(19) United States
(12) Patent Application Publication
(10) Pub. No.: US 2023/0128057 A1
(43) Pub. Date: Apr. 27, 2023

(54) SYSTEMS, METHODS, AND DEVICES FOR EFFICIENT EXECUTION OF ARTIFICIAL NEURAL NETWORKS

(71) Applicant: Infineon Technologies AG, Neubiberg (DE)

(72) Inventors: Muhammad Hassan, Muenchen (DE); Konrad Walluszik, Muenchen (DE); Juergen Schaefer, Oberhaching (DE)

(21) Appl. No.: 17/965,166

(22) Filed: Oct. 13, 2022

(30) Foreign Application Priority Data
Oct. 25, 2021 (DE) 10 2021 127 695.0

(51) Int. Cl. G06N 3/063; G06F 7/544

(52) U.S. Cl. CPC G06N 3/063; G06F 7/5443

(57) ABSTRACT

A system for executing an artificial neural network having a plurality of interconnected nodes, the system includes a memory storing weight values of the neural network. The memory can be configured to a store node value and a mask bit value for each of the plurality of nodes of the neural network. Further the system can include multiply and accumulate (MAC) units to perform operations for determining node values. The system includes a control unit circuitry that, during execution of the neural network, dynamically controls operations of the MAC units to cause a reduction in a number of calculations to be performed by the MAC units. The control unit circuitry causes the MAC units to perform operations involving a subset of the plurality of nodes to avoid performing operations involving nodes of the plurality nodes that are outside of the subset.

### REFERENCE TO RELATED APPLICATIONS

This application claims priority to German Application 10 2021 127 695.0, filed on Oct. 25, 2021. The content of the above-referenced Patent Application is hereby incorporated by reference in its entirety.

### TECHNICAL FIELD

Various embodiments generally relate to artificial neural networks.

### BACKGROUND

Currently, many artificial neural networks (ANNs) include dense layers, including many nodes or neurons. For example, AlexNet is one notable neural network used for classification that includes two dense hidden layers, each including 4096 neurons (e.g., 4096×4096 neurons from layer n−1 to layer n).

### BRIEF DESCRIPTION OF THE DRAWINGS

In the drawings, like reference characters generally refer to the same parts throughout the different views. The drawings are not necessarily to scale; emphasis is instead generally being placed upon illustrating the principles of the invention. In the following description, various embodiments of the invention are described with reference to the following drawings, in which:

FIG. 1 shows a graphical representation of an exemplary trained artificial neural network.

FIG. 2 shows the trained artificial neural network of FIG. 1 after a pruning process has been applied.

FIGS. 3-4 show exemplary graphical representations of a section of a trained artificial neural network according to an exemplary embodiment of the present disclosure.

FIGS. 5A-5G shows a system executing a trained artificial neural network according an exemplary embodiment of the present disclosure.

FIG. 6 shows a graphical depiction of activation functions.

FIG. 7 shows a method according to at least one exemplary embodiment of the present disclosure.

### DESCRIPTION

The following detailed description refers to the accompanying drawings that show, by way of illustration, specific details and embodiments in which the invention may be practiced.

The word “exemplary” is used herein to mean “serving as an example, instance, or illustration.” Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e., one or more. Any term expressed in the plural form that does not expressly state “plurality” or “multiple” likewise refers to a quantity equal to or greater than one. The terms “proper subset”, “reduced subset”, and “lesser subset” refer to a subset of a set that is not equal to the set, i.e., a subset of a set that contains fewer elements than the set.

The terms “at least one” and “one or more” may be understood to include a numerical quantity greater than or equal to one (e.g., one, two, three, four, [ . . . ], etc.).

As used herein, unless otherwise specified, the use of the ordinal adjectives “first”, “second”, “third”, etc., to describe a common object merely indicate that different instances of like objects are being referred to, and are not intended to imply that the objects so described must be in a given sequence, either temporally, spatially, in ranking, or in any other manner.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. However, the term data is not limited to the aforementioned examples and may take various forms and represent any information as understood in the art.

The term “processor” or “controller” as, for example, used herein may be understood as any kind of entity that allows handling data, signals, etc. The data, signals, etc., may be handled according to one or more specific functions executed by the processor or controller.

A processor or a controller may thus be or include an analog circuit, digital circuit, mixed-signal circuit, logic circuit, processor, microprocessor, Central Processing Unit (CPU), Neuromorphic Computer Unit (NCU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

A “circuit” as used herein is understood as any kind of logic-implementing entity, which may include special-purpose hardware or a processor executing software. A circuit may thus be an analog circuit, digital circuit, mixed-signal circuit, logic circuit, processor, microprocessor, signal processor, Central Processing Unit (“CPU”), Graphics Processing Unit (“GPU”), Neuromorphic Computer Unit (NCU), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions, which will be described below in further detail, may also be understood as a “circuit.” It is understood that any two (or more) of the circuits detailed herein may be realized as a single circuit with substantially equivalent functionality. Conversely, any single circuit detailed herein may be realized as two (or more) separate circuits with substantially equivalent functionality. Additionally, references to a “circuit” may refer to two or more circuits that collectively form a single circuit.

As utilized herein, terms “module”, “component,” “system,” “circuit,” “element,” “interface,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

As used herein, a “signal” may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal.

As used herein, a signal that is “indicative of” a value or other information may be a digital or analog signal that encodes or otherwise communicates the value or other information in a manner that can be decoded by and/or cause a responsive action in a component receiving the signal. The signal may be stored or buffered in a computer-readable storage medium before its receipt by the receiving component. The receiving component may retrieve the signal from the storage medium. Further, a “value” that is “indicative of” some quantity, state, or parameter may be physically embodied as a digital signal, an analog signal, or stored bits that encode or otherwise communicate the value.

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electromagnetic wave in the other element without physical contact or intervening components. Further, when a voltage, current, or signal is referred to as being “applied” to an element, the voltage, current, or signal may be conducted to the element by way of a physical connection or by way of capacitive, electromagnetic, or inductive coupling that does not involve a physical connection.

As used herein, “memory” is understood as a non-transitory computer-readable medium where data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory and thus may refer to a collective component comprising one or more types of memory. Any single memory component may be separated into multiple collectively equivalent memory components and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

Unless specifically stated otherwise, discussions herein using words such as “processing,” “computing,” “calculating,” “determining,” “presenting,” “displaying,” or the like may refer to actions or processes of a machine (e.g., a computer/processor/etc.) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Exemplary embodiments of the present disclosure may be realized by one or more computers (or computing devices) reading out and executing computer-executable instructions recorded on a storage medium (e.g., non-transitory computer-readable storage medium) to perform the functions of one or more of the herein-described embodiment(s) of the disclosure. The computer(s) may comprise one or more of a central processing unit (CPU), a microprocessing unit (MPU), or other circuitry, and may include a network of separate computers or separate computer processors. The computer-executable instructions may be provided to the computer, for example, from a network or a non-volatile computer-readable storage medium. The storage medium may include, for example, one or more of a hard disk, a random-access memory (RAM), a read-only memory (ROM), a storage of distributed computing systems, an optical drive (such as a compact disc (CD), digital versatile disc (DVD), or Blu-ray Disc (BD), a flash memory device, a memory card, and the like. By way of illustration, specific details and embodiments in which the invention may be practiced.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

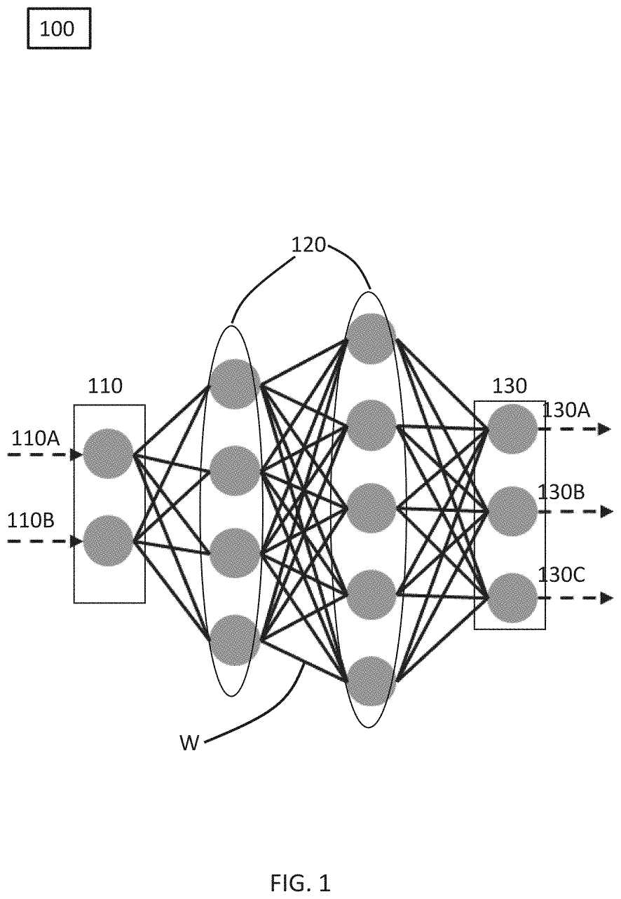

FIG. 1 shows a graphical representation of an exemplary trained neural network 100, including interconnected nodes or neurons. The trained neural network 100 can be a feedforward or multi-level perception (MLP) neural network. The trained neural network 100 includes an input layer 110 with inputs or input nodes 110a and 110b and a plurality of hidden layers 120. The hidden layers 120 each include a plurality of nodes that are interconnected to nodes of other layers. The neural network also includes an output layer 130 with output nodes or neurons 130a and 130b. The lines W represent the weights or weighted connections between nodes/neurons.

Presently, the execution of neural networks, such as the trained neural network 100, includes performing operations or calculations involving “zero multiplications”. The execution can include multiplication involving values that are or are close to zero value and thus do not impact the result of the trained neural network and thus are ultimately unnecessary. Further, performing such calculations or operations results in unnecessary data movement between memories. As the neural networks get larger or more complex, e.g., more interconnected neurons, this leads to more unnecessary calculations and a reduction in energy-efficiency, among other things.

Accordingly, neural networks can be characterized by sparsity, which defines the amount of inclusion of zeros or very small value of weights and (hidden-layer) neurons that do not impact the final calculation of a trained neural network. Existing solutions for exploiting or reducing the sparsity of a trained neural network include removing redundant parameters, such as, for example, by removing weights or certain layers. This pruning or paring of the neural network can decrease the memory footprint of a neural network and help avoid extra calculations during inference.

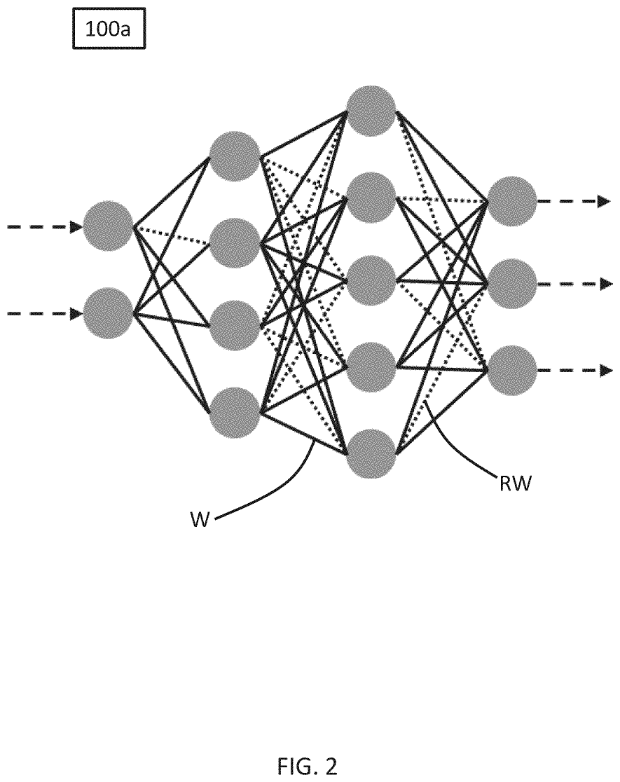

FIG. 2 shows the trained neural network 100a, the same as the trained neural network 100 after a pruning process has been applied. The dotted lines may represent pruned weights or weights removed from the trained neural network 100. The removed weights (RWs), for example, may be weights that have been removed or deleted from a memory or other medium storing the trained neural network 100a or the neural network information for use.

The disadvantages of this approach are that it requires estimations and assumptions as to the weights and hidden layers that would be sparse or involve zero or near zero calculations. Moreover, pruning is static because it is applied to all inputs applied to the neural network, regardless of the pruned weights or hidden layers would qualify as sparse.

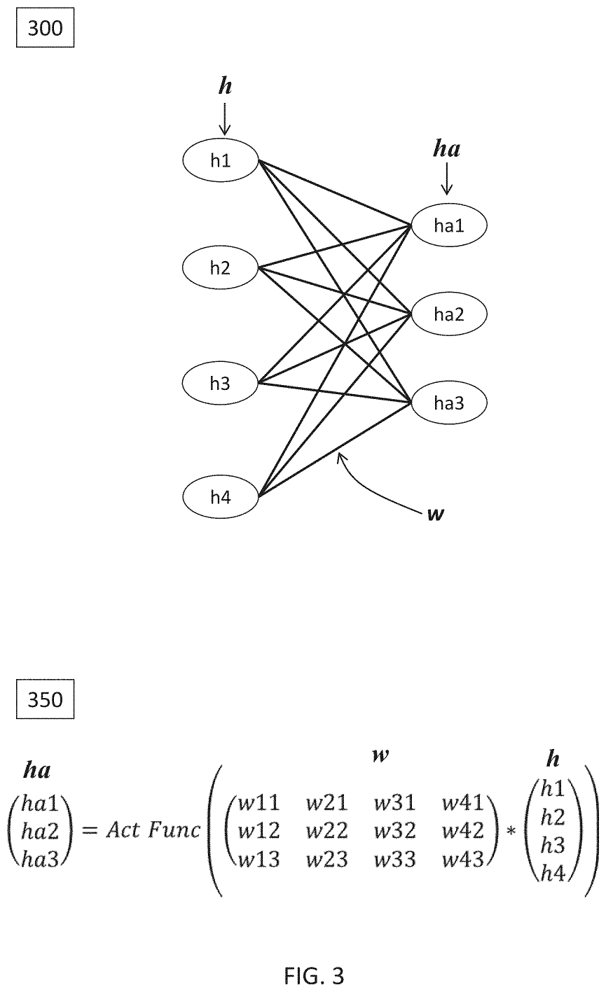

FIG. 3 includes an exemplary representation of a section 300 of a trained neural network. The section 300 shows the connection between two exemplary neighboring hidden layers of a trained neural network. The section 300 may be of a neural network such as an MLP or feedforward type of neural network. However, in other cases, other types of neural networks may also be used.

The section 300 of the neural network includes a hidden layer h which includes nodes h1-h4. The nodes h1-h4 are interconnected or related by weighted connections or weights w to the nodes ha1-ha3 of the next hidden layer ha. The data indicating or reflecting the relationship between nodes, e.g., the values of nodes, the weights, etc. may be stored or maintained in a suitable memory or storage device.

The matrix equation 350 mathematically represents the relationship between the hidden layer h and the hidden layer ha using the weights w, w11-w43. As shown, the values of nodes of the hidden layer h can be represented as a vector that is to be multiplied by the weights, which is represented in a matrix form.

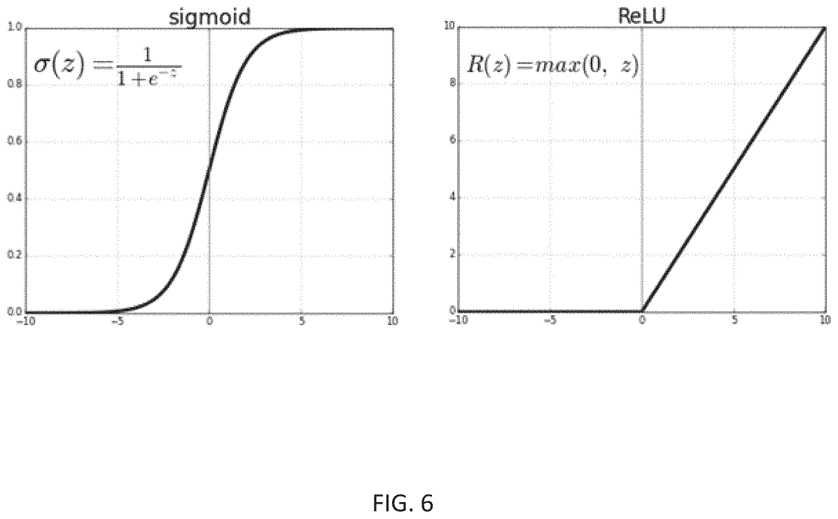

An activation function (Act Func) is applied to the outputs of the multiplication between the hidden layer node h (the node values) and the weights w (w11-w43) to produce node/neuron values. The activation function to be applied may be any suitable function for neural networks, including, for example, a sigmoid function or a Rectified Linear Unit (ReLU) function. Examples of the sigmoid function and the ReLU function are shown in FIG. 6. In general, the ReLU function is the most commonly used activation function in hidden layers. With a ReLU activation function, if a neuron value is negative before the activation function is applied, the output becomes absolute zero. Other activation functions like sigmoid also bring higher negative neurons value close to zero.

Referring back to FIG. 3, the node or neuron values for layer h are already be known (from execution or inference). However, the values for the subsequent neighboring layer ha have not yet been determined. As previously explained, during the execution of a neural network, the node or neuron values of one (hidden) layer can be used with the appropriate corresponding weights to find or determine the node or neuron values of another, e.g., subsequent layer. In this case, the nodes h1-h4 of the h layer can be used in multiple calculations to determine the node values of layer ha.

In exemplary embodiments of the present disclosure, additional information may be present and used to execute a trained neural network more efficiently and avoid many calculations. Data indications may be used to denote or convey the status of the nodes of hidden layers. In one case, the indications may be in mask bits, but other types of indications or designations may be used in other instances.

In various exemplary embodiments of the present disclosure, values of nodes determined during execution (inference) of a trained neural network can be compared to a threshold. For example, an indication, e.g., a mask bit value, can be assigned based on the comparison. As such, the determined mask bit value can indicate or inform nodes that have a node value large enough (e.g., larger than a threshold) to be needed or significant for further calculations in the execution of the trained neural network. Such nodes can be considered as “strong nodes”.

Moreover, a mask bit can indicate or inform nodes that have a “low” enough (e.g., lower than a threshold) value to be considered unnecessary to perform calculations with the node to execute the neural network. Such nodes may be considered as “weak nodes”. In some embodiments described herein, the weak nodes may not be used or bypassed in executing a neural network.

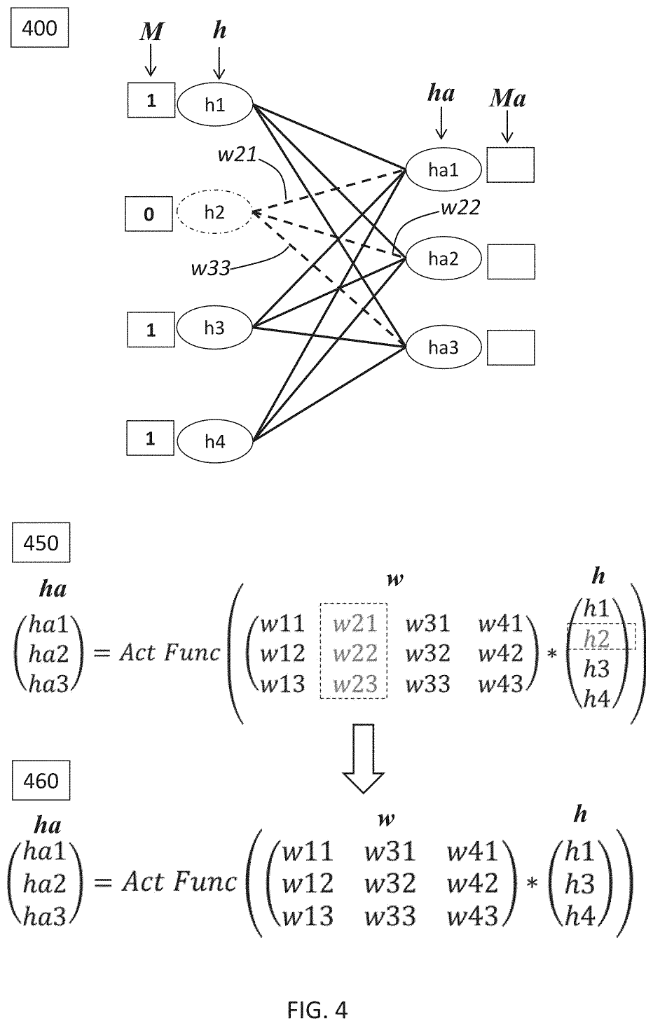

FIG. 4 shows graphically the trained neural network section 400. The neural network section 400 is the same as section 300 of FIG. 3, except that the node h2 and its corresponding weights (w21, w22, and w23) for the next hidden layer, ha, are in dashed line. The dashed line can graphically represent the removal of certain calculations for determining the nodes ha1-ha3. Referring to the matrix calculation 450, the weights and nodes value of h2 can be removed. By effectively removing the node h2 and the corresponding weights w21, w22, and w23 from being used, a new condensed or reduced matrix equation 460 can be implemented to execute the neural network. Compared to matrix equation 350, which involves a matrix multiplication of 4×4 matrix with a 4×1 matrix (vector), equation 460 involves a 3×3 matrix to be multiplied with a 3×1 matrix (vector). As a result, the computations needed are reduced in this example. The number of computations to be performed, e.g., by a MAC, can be significantly decreased. In the case of larger neural networks and thus larger matrixes to be used, the computational savings can dramatically increase.

Specifically, in the example of FIG. 4, mask bit values M can indicate the status or type of nodes of layer h. Each of the nodes h1-h4 may include or be associated with a corresponding mask bit that indicates its status. In exemplary embodiments of the present disclosure, executing a trained neural network and determining node values can include determining or assigning mask bit values to the nodes based on the nodes' value or other characteristics. Computational efficiencies can be realized by using the mask bit values to execute the trained neural network.

In the example of FIG. 4, a mask bit value of “1” is assigned to the nodes having a node value greater than a threshold. Again, such nodes can be considered as “strong nodes”. Similarly, the mask bit value of “0” is assigned “weak nodes” or nodes having a node value less than or equal to the given threshold. In some examples, the threshold T may be set at a low value, e.g., 10⁻³, 10⁻⁴, 10⁻⁵, etc., so nodes with values less than the threshold may be effectively considered a node value of zero (0) or be considered substantially zero.

As shown in FIG. 4, node h2 has a mask bit value of zero, indicating that node h2 has a value less than or equal to the predefined or predetermined threshold value. In other words, the node or neuron h2 is a weak node with a small node value that does not significantly contribute to or impact the computations for the next hidden layers. However, the nodes h1, h3, and h4 are strong nodes to determine the layer ha. Accordingly, the node value and weights associated with the h2 are removed, graphically depicted with the dashed curves or lines in FIG. 4.

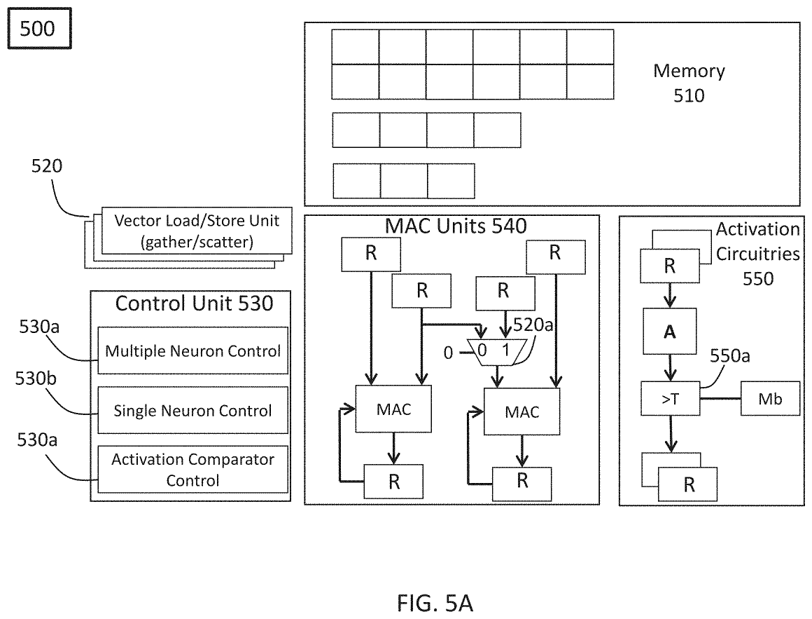

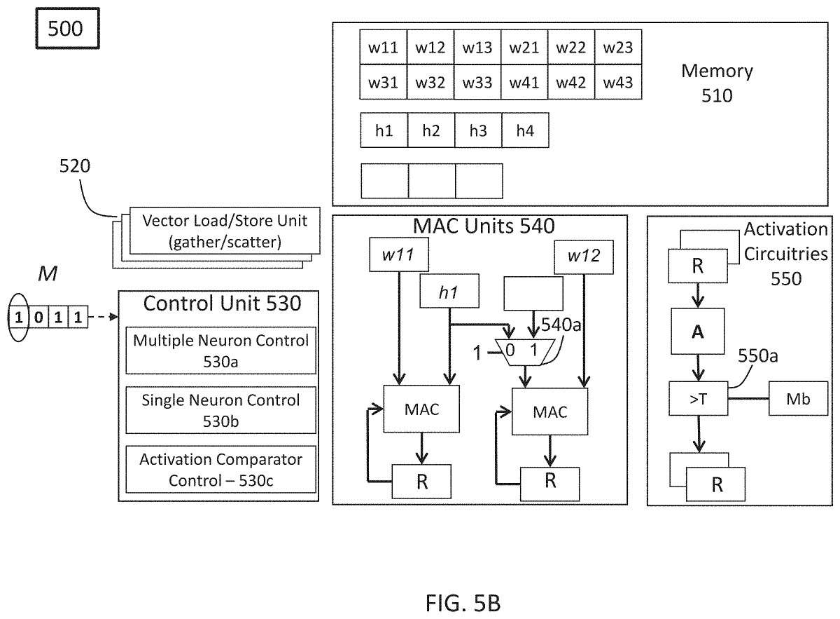

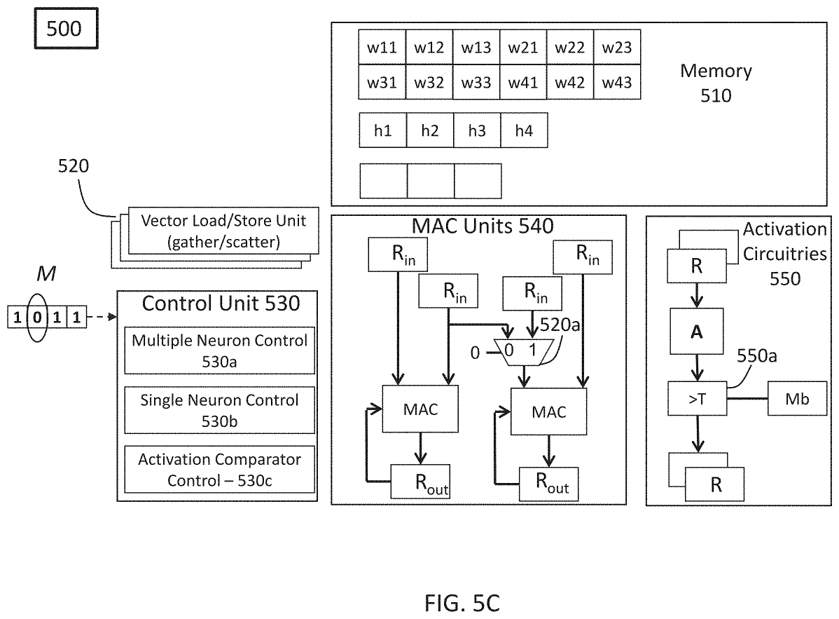

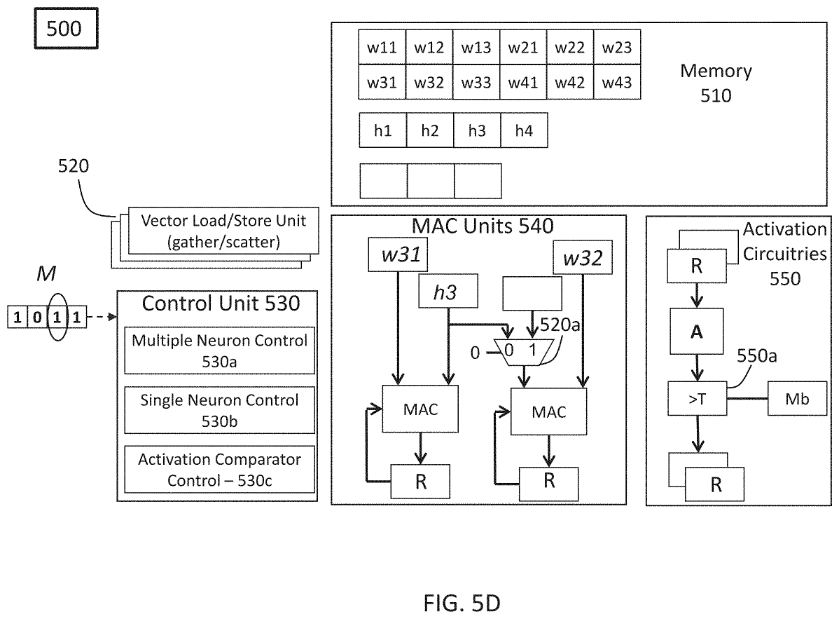

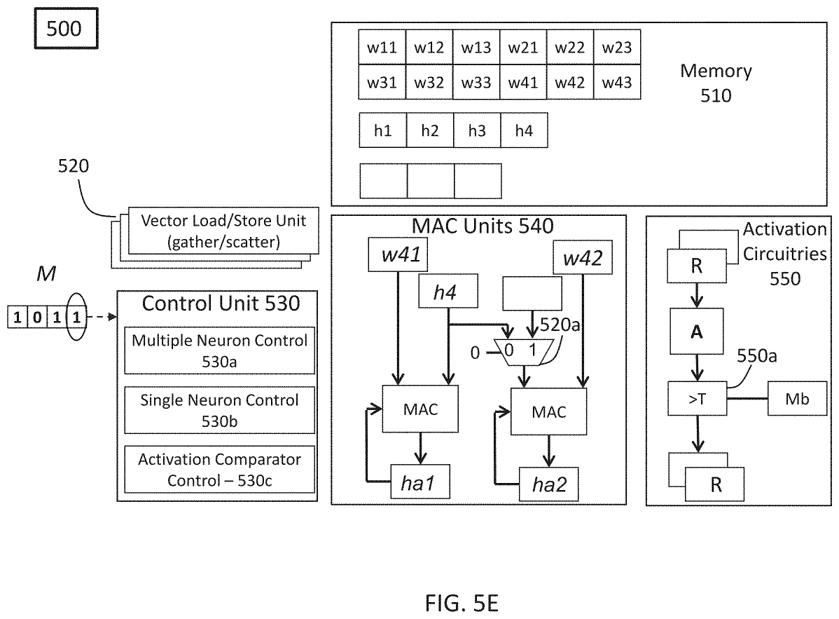

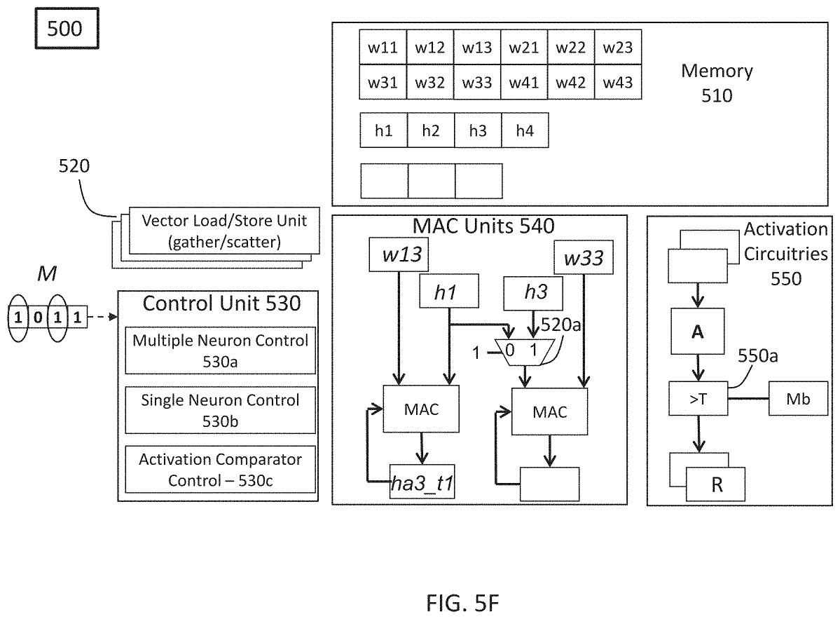

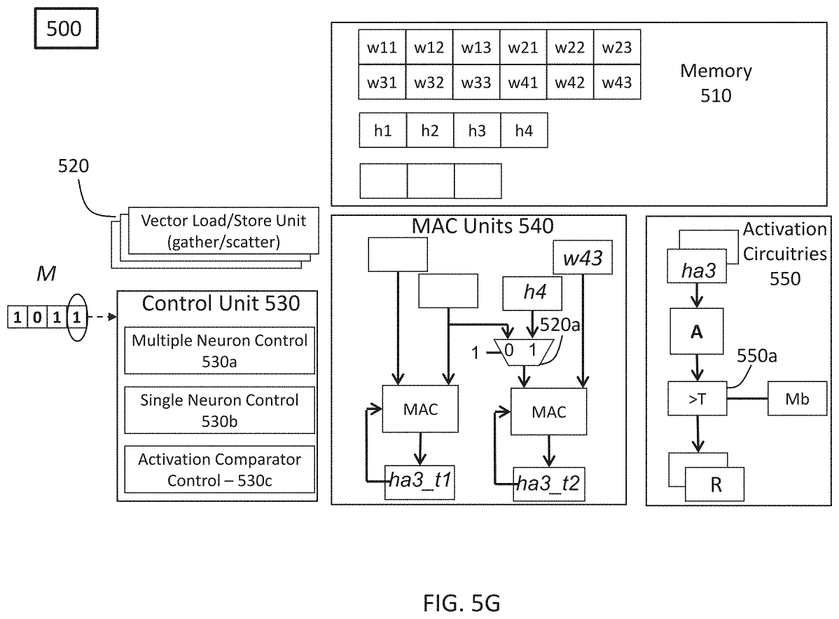

FIG. 5 shows an exemplary system 500 that may be used for executing a trained neural network according to exemplary embodiments of the present disclosure. The system 500 may be used on a trained neural network of any suitable type, such as a feedforward neural network (e.g., an MLP), a recurrent neural network (RNN) (e.g., long short-term memory networks (LSTMs), gated recurrent units (GRUs), recursive neural network, etc.), a convolution neural network, etc. For example, the system 500 may execute a trained neural network including a plurality of interconnected nodes and may include a plurality of layers, each having one or more nodes/neurons. A trained neural network may include hidden layers between an input and an output layer.

As shown in FIG. 5A, the system 500 may include a memory 510. The memory 510 can include the data defining a trained neural network. For example, the memory 510 may include or store the weights and node values of the trained neural network.

The system 500 further includes one or more load/store units (LSU) 520, at least one control unit circuitry 530, one or more multiply and accumulate (MAC) units 540, and one or more activation circuitries 550. Connections, e.g., physical connections such as buses or other data lines, between the components may not be shown.

The LSU or vector LSU 520 can be configured to access, retrieve, and provide data between the components of the system 500. For example, the LSU 520 may retrieve or access the weights or node values, e.g., from memory 510, and provide them to other components of the system 500.

The control unit circuitry 530 may include hardware or processing circuitry, e.g., one or more processors programmed or configured to control one or more aspects of the system 500. In one instance, the control unit circuitry 530 can control which parameters or which operations are to be performed during the execution of a trained neural network. In FIG. 5, the control unit circuitry 530 includes a multiple neuron control component 530a to control a MAC unit 540 to perform operations for multiple nodes or neurons. Similarly, the control unit circuitry 530 can include a single neuron component 530b to control a MAC unit 540 to perform operations for a single or individual node or neuron. Additionally, the control unit circuitry 530 includes an activation comparator control 530a.

The MAC units 540 are each a computational component that performs various calculations or mathematical operations. Each MAC unit 540 can include one or more registers R for storing data received by or produced by the MAC units. Further, each of the MAC units 540 can include a neuron control component 530a that, when enabled, can allow the respective MAC unit 540 to perform calculations or operations for multiple neurons, e.g., during execution or implementation of a trained neuronal network or be triggered to only allow processing for a single node. In the examples herein, one or more of the MAC units 540 may perform calculations for more than one neuron at a time by obtaining weights for more than one node of the hidden layer to be determined.

Further, each MAC unit 540 can include the MAC components (MACs) that perform multiplication and accumulations based on inputs received by the respective MAC unit 540.

The activation circuitries 550 may perform operations related to applying an activation function to inputs, e.g., values calculated by the one or more MAC units 540. The activation circuitries 550 can also include one or more R registers for receiving and storing outputs. Each of the activation circuitries 550 include an activation component A. The activation component A may be a hardware component, such as processing circuitry, that applies an activation function to inputs, which in examples herein can be outputs of the MAC units 540. An output of the activation component A can be the node value for a particular node.

Further, the activation circuitry 550 can be configured to compare the output of the activation component A to a (predefined or predetermined) threshold value. This comparison can be used to producing or assigning indications, e.g., mask bits to nodes. Each of the activation circuitries 550 can include a comparator 550a that compares the output of the activation component A to a threshold T and produces an output, e.g., a mask bit Mb.

In the example of FIGS. 5B-5G, the system 500 may be configured to calculate the hidden layer ha shown in the neural network section shown in FIGS. 3 and 4 using the hidden layer h. The control unit circuitry 530 can be configured to systemically cause the LSU 520 to load the node/neuron values and associated weights for the calculation into one or more MAC units 540.

As mentioned, memory 510 stores the neural network configuration data, including data indicating the relationships between nodes, including the weights of interconnected nodes. The w weights (w11-w43) connecting the hidden layer h and hidden layer ha, and the node values of the hidden layer h, h1-h4 are shown stored in the memory 510. Further, the memory 510 may store the mask bits M for the hidden layer h. The memory 510 does not yet have node values for the nodes ha1-ha3 of hidden layer ha. Hence, the trained neural network has been partially executed.

During the trained neural network implementation, the system 500 can be configured to avoid or skip certain computations. Referring back to FIG. 4, the system 500 can be configured to determine the node layer ha without using certain nodes or their associated nodes values and weights. As shown in FIG. 4, the dashed-boxed sections of the equation 450 can be effectively removed. Accordingly, the system 500 can be configured to skip performing calculations involving the weights w21-w23 and node value of node h2. The system 500 can “know” which nodes to use by the mask bit. As shown in FIG. 4, node h2 has been identified or labeled as a “weak node” by the “0” mask bit designation. As previously explained, the value of the node h2 is low or insignificant not to be used. Accordingly, system 500 is configured to perform calculations presented by the modified equation 460 of FIG. 4 instead of equation 450.

Therefore, for system 500 to determine the values of the nodes for the hidden layer ha, data indicating the state of the nodes (e.g., mask bits) are transferred or sent to the control unit circuitry 530. The control unit circuitry 530 can then read and react to the state of the nodes.

As shown starting in FIG. 5B, the control unit circuitry 530 considers the mask bits. The first mask bit, a “1” (encircled), corresponds to the first node h1 of layer h. In response to reading or evaluating this first mask bit, the control unit circuitry 530 can be configured to initiate or cause the loading of weights connecting the first node h1 to the nodes ha1 and ha2 of the next layer ha and the loading of the value of the node h1 into at least one of MAC units 540. In FIG. 5B, the control unit circuitry 530 can cause the LSU 520 to retrieve and load the weights w11 and w12 and node value h1 into one of the MAC units 540 to determine the nodes' values ha1 and ha2. As previously described, the mask bit value of “1” for the node h1 indicates that node h1 is a strong node or belongs to a reduced subset or a group of “approved nodes” used to execute the trained artificial neural network. Further as shown, the control unit circuitry 530, e.g., through the multiple neuron control component 530a, can enable the individual MAC unit 540 to perform operations for two nodes, ha1 and ha2, by enabling the control component 540a, e.g., with “0” input. In this case, the control unit circuitry 530 enables a signal with a “0” to control the control circuitry 520a (e.g., multi-neuron control component) of the MAC unit 540.

After loading node value of h1 and weights w11 and w12, the MAC unit 540 can perform mathematical operations or calculations to determine the multiplicative product of h1 and w11 (for ha1) and the multiplicative product of h1 and w12 (for ha2). These results (multiplicative products) can each be stored, for example, in the registers R coupled to the output of the MAC components.

Subsequently, the control unit circuitry 530 can be configured further cause the LSU to load into the same MAC unit 540, the next parameters for determining the first and second nodes, ha1 and ha2. Before any loading command, the control unit circuitry 530 consider using the node (and its associated node value and associated weights). However, in this case, the control unit circuitry 530 can determine that the next node, h2, is weak because its mask bit value is “0”.

Therefore, instead of causing the node value of h2 and associated weights for the first and second nodes of the next hidden layer ha to be loaded, the control unit circuitry 530 proceeds to consider the next node h3 in the execution of the trained artificial neural network. In doing so, the control unit circuitry 530 effectively causes the system 500 to skip performing operations, determinations, or calculations involving the node h2. No operations involving the node h2 and its associated node value and weights are performed for layer ha. Accordingly, FIG. 5C shows no loading of a node value h2 nor any loading of any associated weights of h2 into any MAC unit 540

Subsequently, in FIG. 5D, the control unit circuitry 530, can determine the status of the third node h3 by evaluating its associated mask bit. The node h3 belongs to the strong nodes subgroup or reduced subset because its mask bit has a value of “1”. Thus, the control unit circuitry 530 can cause the LSU 520 to retrieve and provide the node value of h3 and the weights (w31 and w32) for the first and second nodes of the layer ha to the same MAC unit 540 that was previously used. The multiple neuron control component 530a of the control unit circuitry 530 can enable (e.g., send a signal to enable) the multi-neuron functionality of the MAC unit 540. Further, the MAC unit 540 determines the multiplicative product of h3 and w31 and h3 and w32. The MAC unit 540 accumulates these products with the previously determine multiplicative products, h1 and w11, h1 and w12. Each accumulation can be stored, e.g., in respective a register of the MAC unit 540 for further use or processing.

In FIG. 5E, the control unit circuitry 530 can consider the next node, node h4, of layer h for executing the neural network. The control unit circuitry 530 can determine based on the mask bit for node h4 that the node value of h4 and the associated weights w41 and w42 can be used to determining the nodes ha1 and ha2. In this instance, the node h4 is a strong node because its mask bit has a value of “1”. Accordingly, the control unit circuitry 530 can cause the LSU 520 to retrieve and load the node value of h4 and the weights w41 and w42 into the MAC unit 540 that performed the previous operations for the nodes ha1 and ha2.

The multiple neuron control component 530a of the control unit circuitry 530 can again enable (e.g., send a signal to enable) the multi-neuron functionality of the MAC unit 540. The MAC unit 540 determines the multiplicative product of h4 and w41 and h4 and w42, respectively, for the nodes ha1 and ha2. The products are respectively accumulated with the previously determined multiplicative products for ha1 and ha2. Each accumulation can be stored, e.g., in respective a register of the MAC unit 540 for further use or processing.

Since node h4 is the last node for layer h, accumulation produces the preliminary node values for ha1 and ha2. Thus, the control unit circuitry 530 can be configured to activate or prompt one of the activation circuitries 550 to obtain the calculated values for ha1 and ha2. The activation circuitry 550, using the activation component A, applies the activation function to the calculated node values to produce the respective node values for ha1 and ha2, which can be stored in registers R.

Further, the activation circuitry 550 can then apply the comparator circuitry or comparator 550a to each node's values determined by the activation component A. The comparator 550a can determine whether the node value generated by the activation component A is greater than a threshold and generate a corresponding indicator, e.g., a mask bit based on the comparison result.

For example, if the node value is greater or equal to the threshold T, a mask bit value (Mb) of “1” can be generated. If the node value is less than the threshold T, a mask bit value (Mb) of “0” can be generated.

The generated node values and the corresponding mask bits Mb from the activation circuitry 550 can be retrieved, e.g., by the LSU 520, and provided into the memory 510. They can be used to determine other nodes, e.g., of the next layer of the trained ANN.

Further, another MAC unit 540 may independently generate the node values for ha1 and ha2. FIG. 5F shows another (second) MAC unit 540 of the plurality of MAC units 540 that can be used for executing the neural network, and more specifically, perform calculations or determinations for the node ha3. The MAC unit 540 of FIG. 5F may operate concurrently with the MAC unit used in FIGS. 5B-5E.

In FIG. 5F, the control unit circuitry 530 can cause the parameters for determining the third node ha3 to be loaded into the second MAC unit 540. First, in this case, based on their mask bit values, the node value of h1 and the associated weights w13 and the node value h3 and associated weight w33 can be loaded into the second MAC unit 540. The control unit circuitry 530 avoids or skips loading the parameters associated with the node h2.

After loading the parameters (h1, w31, h3, and w33), the second MAC unit 540 can perform operations/calculations. The single neuron component 530b of the control unit circuitry 530 can enable the second MAC unit 540 to function in a single neuron mode. The product, h1 and w31, and the product h3 and w33 produced by the second MAC unit can be accumulated or summed together, in this case, in a single intermediate data, ha3_t1.

After generating the intermediate node data ha3_t1, the control unit circuitry 530 can cause the LSU 520 to retrieve and load into the second MAC unit 540 the parameters of the fourth node of the layer h, for producing the third node ha3 of the layer ha. Namely, the parameters of the fourth node h4 for determining the third node of the next layer ha (h4 and w43) are loaded into the second MAC unit as shown in FIG. 5G. Again, the single neuron component 530b of the control unit circuitry 530 can keep enabling the control circuitry 520a of the second MAC unit 540 to function in a single neuron mode.

The second MAC unit 540, as shown, can produce or generate the product of h4 and w43, and the intermediate product ha3_t2. The second MAC unit 540 can accumulate the intermediate products ha3_t1 and ha3_t2 to produce a final node calculation for ha3.

After producing a node calculation for ha3 in the second MAC unit 540, the control unit circuitry 530 can trigger at least one activation circuitry 550 to operate. One activation circuitry 550 obtains the node calculation for ha3 and applies the activation function using the activation component A. The activation component A produces the node value for ha3. Further, the comparator 550a compares the node value ha3 to the threshold T to produce a status or group indication, e.g., a mask bit Mb, depending on the comparison result by the comparator 550a. The produced node value ha3 and the corresponding mask bit Mb can be sent, e.g., via the LSU 520, to the memory 510 for storage and later for further use in the execution of the trained ANN.

Then system 500 can continue to execute the trained neural network by determining the next hidden layer hb (not shown) based on the produced nodes values and mask bits determined for hidden layer ha. The same type of operations and actions can be performed again by the memory 510, the LSU 520, the control unit circuitry 530, the one or more MAC units 540, and the one or more activation circuitries 550 to determine the values of the next layer. In doing so, calculations or operations nodes have been determined to be in the group of weak nodes, e.g., have a mask bit value of “0” can be skipped or avoided. Instead, only calculations or operations involving strong nodes, e.g., having a mask bit value of “1” can be performed.

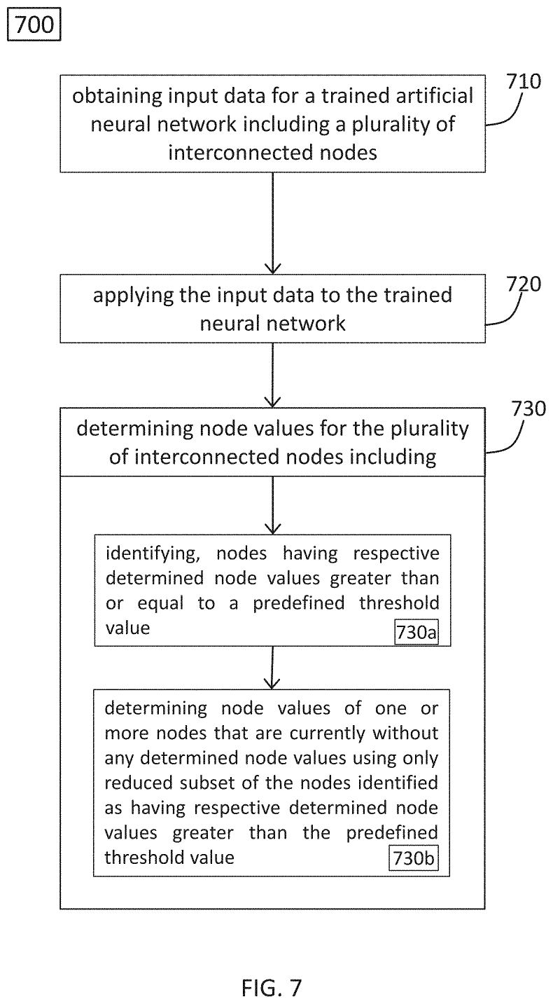

FIG. 7 shows an exemplary method 700 for executing a trained artificial neural network according to at least one exemplary embodiment of the present disclosure. Method 700 includes at 710 obtaining input data for a trained artificial neural network, including a plurality of interconnected nodes. At 720, the method further includes applying the input data to the trained neural network. The method includes, at 730, determining node values for the plurality of interconnected nodes. This determining includes, at 730a, identifying nodes having respective determined node values greater than or equal to a predefined threshold value, and at 730b, determining node values of one or more nodes that are currently without any determined node values using only the reduced subset of nodes identified as having respective determined node values greater than the predefined threshold value.

The following examples pertain to further aspects of this disclosure:

Example 1 is a system for executing a pre-trained artificial neural network including a plurality of interconnected nodes, wherein the system includes: at least one memory including weight values of the pre-trained neural network and configured to a store node value and a mask bit value for each of the plurality of nodes of the pre-trained neural network; one or more multiply and accumulate (MAC) units configured to perform operations for determining node values; a control unit circuitry configured, during execution of the neural network, to dynamically control operations of the one or more MAC units so as to cause a reduction in a number of calculations to be performed by the one or more MAC units including to cause the one or more MAC units to perform operations involving a subset of the plurality of nodes and to cause the one or more MAC units to avoid performing operations involving nodes of the plurality nodes that are outside of the subset that the respective MAC units would otherwise perform if the respective nodes were identified as being in the subset.

Example 2 is the subject matter of Example 1, wherein the control unit circuitry can be configured, during execution of the neural network, to identify nodes having node values within a predefined threshold range as belonging outside the subset to identify nodes having node values are outside the predefined threshold range as belonging in the subset.

Example 3 is the subject matter of Example 2, wherein the control unit circuitry configured to identify nodes having node values that are within the predefined threshold range as belonging outside of the subset or to identify nodes having node values that are outside the predefined threshold range as belonging in the subset can include the control unit circuitry being configured to generate a corresponding mask bit value to identifying nodes as belonging outside or in the subset.

Example 4 is the subject matter of Example 3, wherein the control unit circuitry to cause the one or more MAC units to avoid performing operations involving nodes of the plurality nodes that are outside of subset can further include the control unit circuitry to cause the one or more MAC units to avoid performing operations using the respective node values from nodes identified by the corresponding mask bit values as being outside of the subset.

Example 5 is the subject matter of Example 3 or 4, which can further include one or more activation circuitries configured to apply an activation function to respective outputs of the one or more MAC units.

Example 6 is the subject matter of Example 5, wherein the one or more activation circuitries can be further configured to compare respective outputs of the activation function to the predefined threshold range, and generate the mask bit values for nodes based the respective comparisons.

Example 7 is the subject matter of any of Examples 1 to 6, which can further include: one or more vector load/store units configured to transfer data between the at least one memory unit, the one or more MAC units, and/or the control unit circuitry, wherein during execution of the neural network, the control unit circuitry can be further configured to dynamically cause the vector load/store unit to retrieve from the at least one memory and load into the one or more MAC units, node values from and weights associated with the subset of nodes and configured to avoid causing the vector/load store unit to retrieve from the at least one memory and load into the one or more MAC units, node values from and weights associated with nodes outside the subset of nodes.

Example 8 is the subject matter of any of Examples 1 to 6, wherein the predefined threshold range can be a range including a value of zero.

Example 9 is the subject matter of any of Examples 1 to 8, wherein the trained artificial neural network can be a trained feedforward artificial neural network including a plurality of layers, the plurality of layer including an input layer, one or more hidden layers, and an output layer, wherein each layer comprises one or more of the plurality of nodes, and wherein the nodes of neighboring layers are related by one or more the weighted connections.

Example 10 is the subject matter of any of Examples 1 to 8, wherein the artificial neural network can be a convolutional neural network.

Example 11 is the subject matter of any of Examples 1 to 8, wherein the artificial neural network can be a recurrent neural network.

Example 1 A is a method for facilitating execution of a trained artificial neural network comprising a plurality of interconnected nodes, the method including: obtaining input data for the trained neural network; applying the input data to the trained neural network; and determining node values for the plurality of interconnected nodes. Determining the node values for the plurality of interconnected nodes includes identifying nodes respectively having previously determined node values greater than or equal to a predefined threshold value; and determining node values for nodes without a determined node value using only the nodes identified as respectively having determined node values greater than the predefined threshold value.

Example 2A is the subject matter of Example 1A, wherein determining node values for the plurality of interconnected nodes may further include identifying, nodes having respectively determined node values less than the predefined threshold value.

Example 3A is the subject matter of Example 1A or 2A, wherein determining node values of one or more nodes without any determined node values may further include performing, using one or more multiply-accumulate (MAC) units, one or more calculations using the node values and associated weight values from one or more of the nodes identified as having respectively determined node values greater than or equal to the predefined threshold value.

Example 4A is the subject matter of Example 3A, wherein determining node values of one or more nodes without any determined node values may further include causing the one or more MAC units to avoid performing any calculations using the node values and associated weight values of the nodes identified as having respectively determined node values less than the predefined threshold value.

Example 5A is the subject matter of Example 3A or 4A, wherein determining node values of one or more nodes without any determined node values using only the nodes identified as having respective determined node values greater than the predefined threshold value may further include loading into the one or more MAC units, at one or more instances, one or more node values and one or more weight values only for nodes identified as having respective determined node values greater than the predefined threshold.

Example 6A is the subject matter of any of Examples 1 A to 5A, which may further include determining an identifier for nodes having a determined node values, the identifier indicating whether the node has a respective node value greater than or equal to the predefined threshold or has a respective node value less than the predefined threshold.

Example 7A is the subject matter of Example 3A, wherein a control unit circuitry coupled to the one or MAC units may cause the one or more MAC units to perform one or more calculations using only the node values and associated weight values from the nodes identified as having respective determined node values greater than or equal to the predefined threshold value.

Example 8A is the subject matter of Example 3A, wherein determining node values of one or more nodes without any determined node values may further include applying an activation functions to one or more outputs of the one or MAC units.

Example 9A is the subject matter of any of Examples 1 A to 8A, wherein the artificial neural network can be a feedforward neural network including a plurality of layers, the plurality of layer including an input layer, one or more hidden layers, and an output layer, wherein each layer comprises one or more of the plurality of nodes, and wherein the nodes of neighboring layers are related by one or more the weighted connections.

Example 10A is the subject matter of any of Examples 1 A to 8A, wherein the artificial neural network can be a convolutional neural network.

Example 11A is the subject matter any of Examples 1 A to 8A, wherein the artificial neural network can be a recurrent neural network.

It should be noted that one or more of the features of any of the examples above may be suitably or appropriately combined with any one of the other examples or with embodiments disclosed herein.

The foregoing description has been given by way of example only and it will be appreciated by those skilled in the art that modifications may be made without departing from the broader spirit or scope of the invention as set forth in the claims. The specification and drawings are therefore to be regarded in an illustrative sense rather than a restrictive sense.

The scope of the disclosure is thus indicated by the appended claims and all changes which come within the meaning and range of equivalency of the claims are therefore intended to be embraced.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A system for executing a pre-trained artificial neural network comprising a plurality of interconnected nodes, the system comprising:
at least one memory including weight values of the pre-trained artificial neural network and configured to a store node value and a mask bit value for each of the plurality of interconnected nodes of the pre-trained artificial neural network;
one or more multiply and accumulate (MAC) units configured to perform operations for determining node values; and
a control unit circuitry configured, during execution of the pre-trained artificial neural network, to dynamically control operations of the one or more MAC units so as to cause a reduction in a number of calculations to be performed by the one or more MAC units comprising to cause the one or more MAC units to perform operations involving a subset of the plurality of interconnected nodes and to cause the one or more MAC units to avoid performing operations involving nodes of the plurality of interconnected nodes that are outside of the subset.

2. The system of claim 1, wherein the control unit circuitry is configured, during execution of the pre-trained artificial neural network, to dynamically control operations of the one or more MAC units so as to avoid performing operations involving the nodes of the plurality of interconnected nodes that are outside of the subset, wherein the operations that are avoided for the respective MAC units would otherwise be performed by the one or more MAC units if the respective nodes were identified as being in the subset.

3. The system of claim 1, wherein the control unit circuitry is configured, during execution of the pre-trained artificial neural network, to identify nodes having node values within a predefined threshold range as belonging outside the subset or to identify nodes having node values that are outside the predefined threshold range as belonging in the subset.

4. The system of claim 3, wherein the control unit circuitry is configured to identify nodes having node values that are within the predefined threshold range as belonging outside of the subset or to identify nodes having node values that are outside the predefined threshold range as belonging in the subset comprises the control unit circuitry being configured to generate a corresponding mask bit value to identifying nodes as belonging outside or in the subset.

5. The system of claim 4, wherein the control unit circuitry to cause the one or more MAC units to avoid performing operations involving nodes of the plurality of interconnected nodes that are outside of the subset comprises the control unit circuitry to cause the one or more MAC units to avoid performing operations using the respective node values from nodes identified by the corresponding mask bit values as being outside of the subset.

6. The system of claim 5, further comprising:
one or more activation circuitries configured to apply an activation function to respective outputs of the one or more MAC units.

7. The system of claim 6, wherein the one or more activation circuitries is further configured to compare respective outputs of the activation function to the predefined threshold range, and generate the mask bit values for nodes based the respective comparisons.

8. The system of claim 1, further comprising:
one or more vector load/store units configured to transfer data between the at least one memory, the one or more MAC units, and/or the control unit circuitry,
wherein during execution of the pre-trained artificial neural network, the control unit circuitry is further configured to dynamically cause the one or more vector load/store units to retrieve from the at least one memory and load into the one or more MAC units, node values from and weights associated with the subset of nodes and configured to avoid causing the one or more vector load/store units to retrieve from the at least one memory and load into the one or more MAC units, node values from and weights associated with nodes outside the subset of nodes.

9. The system of claim 3, wherein the predefined threshold range is a range including zero.

10. The system of claim 1, wherein the trained artificial neural network is a trained feedforward artificial neural network including a plurality of layers, the plurality of layers including an input layer, one or more hidden layers, and an output layer, wherein each layer comprises one or more of the plurality of interconnected nodes, and wherein nodes of neighboring layers are related by one or more weighted connections.

11. The system of any of claim 1, wherein the pre-trained artificial neural network is a convolutional neural network.

12. The system of any of claim 1, wherein the pre-trained artificial neural network is a recurrent neural network.

13. A method for facilitating execution of a trained artificial neural network comprising a plurality of interconnected nodes, the method comprising:
obtaining input data for the trained artificial neural network;
applying the input data to the trained artificial neural network;
determining node values for the plurality of interconnected nodes comprising:
identifying nodes respectively having previously determined node values greater than or equal to a predefined threshold value; and
determining node values for nodes without a determined node value using only the nodes identified as respectively having determined node values greater than the predefined threshold value.

14. The method of claim 13, wherein determining node values for the plurality of interconnected nodes further comprises:
identifying nodes having respectively determined node values less than the predefined threshold value.

15. The method of claim 13, wherein determining the node values of the one or more nodes without any determined node values further comprises:
performing, using one or more multiply-accumulate (MAC) units, one or more calculations using the node values and associated weight values from one or more of the nodes identified as having respectively determined node values greater than or equal to the predefined threshold value.

16. The method of claim 15, wherein determining the node values of the one or more nodes without any determined node values further comprises causing the one or more MAC units to avoid performing any calculations using the node values and associated weight values of the nodes identified as having respectively determined node values less than the predefined threshold value.

17. The method of claim 15, wherein determining the node values of the one or more nodes without any determined node values using only the nodes identified as having respective determined node values greater than the predefined threshold value further comprises loading into the one or more MAC units, at one or more instances, one or more node values and one or more weight values only for nodes identified as having respective determined node values greater than the predefined threshold value.

18. The method of claim 13, further comprising:
determining an identifier for nodes having a determined node value, the identifier indicating whether the node has a respective node value greater than or equal to the predefined threshold value or has a respective node value less than the predefined threshold value.

19. The method of claim 15, wherein a control unit circuitry coupled to the one or MAC units causes the one or more MAC units to perform one or more calculations using only the node values and associated weight values from the nodes identified as having respective determined node values greater than or equal to the predefined threshold value.

20. The method of claim 15, wherein determining node values of one or more nodes without any determined node values further comprises:
applying an activation function to one or more outputs of the one or MAC units.

21. The method of claim 13, wherein the trained artificial neural network is a feedforward neural network including a plurality of layers, the plurality of layers including an input layer, one or more hidden layers, and an output layer, wherein each layer comprises one or more of the plurality of interconnected nodes, and wherein the nodes of neighboring layers are related by one or more weighted connections.
